(19) United States
(12) Patent Application Publication
(10) Pub. No.: US 2022/0154057 A1
(43) Pub. Date: May 19, 2022

(54) REFRIGERANT BLENDS IN FLOODED SYSTEMS

(71) Applicant: THE CHEMOURS COMPANY FC, LLC, WILMINGTON, DE (US)

(72) Inventors: CHARLES CLINTON ALLGOOD, ELKTON, MD (US); BARBARA HAVILAND MINOR, THE VILLAGES, FL (US); LUKE DAVID SIMONI, WILMINGTON, DE (US); DAVID MATTHEW SNYDER, SWARTHMORE, PA (US)

(73) Assignee: THE CHEMOURS COMPANY FC, LLC, WILMINGTON, DE (US)

(21) Appl. No.: 17/598,502

(22) PCT Filed: Apr. 28, 2020
(86) PCT No.: PCT/US20/30204

§ 371 Date: Sep. 27, 2021

Related U.S. Application Data
(60) Provisional application No. 62/840,312, filed on Apr. 29, 2019.

(51) Int. Cl. C09K 5/04; F25B 45/00

(52) U.S. Cl. CPC C09K 5/045; F25B 45/00; C09K 2205/43; C09K 2205/122; C09K 2205/126; C09K 2205/22

(57) ABSTRACT

A refrigeration system including a flooded evaporator. The flooded evaporator additionally includes a liquid evaporator refrigerant composition and a vapor evaporator refrigerant composition. The liquid refrigerant composition includes difluoromethane (HFC-32), and 2,3,3,3-tetrafluoropropene (R-1234yf) and the vapor refrigerant composition includes difluoromethane (HFC-32), and 2,3,3,3-tetrafluoropropene (R-1234yf). The mass fraction of difluoromethane in the liquid evaporator refrigerant composition is lower than the mass fraction of difluoromethane in the vapor evaporator refrigerant composition and the mass fraction of 2,3,3,3-tetrafluoropropene in the liquid evaporator refrigerant composition is greater than the mass fraction of 2,3,3,3-tetrafluoropropene in the vapor evaporator refrigerant composition.

### FIELD OF DISCLOSURE

The present invention is directed to refrigerant compositions and flooded evaporator systems utilizing said compositions.

### BACKGROUND INFORMATION

A large number of chillers and industrial refrigeration systems operating today with flooded evaporators use R-22, a high GWP, ozone depleting pure fluid, or R-507A a high GWP azeotrope as the refrigerant. Examples of chillers systems using flooded evaporators include ice rinks, commercial and industrial air conditioning, and commercial and industrial refrigeration such as process cooling, cold storage, and food processing, preparation and preservation by cooling or freezing. Nearly all replacements for R-22/R-507A are multi-component blends, which generally do not perform well due to differential evaporation and segregation of the blend components in flooded evaporator systems. Bivens, et al., (ASHRAE Transactions: Symposia, pages 777-780, 1997), report replacement of R-22 with a zeotropic blend containing R-32, R-125 and R-134a. Their study revealed cooling capacity decrease of 36% and power requirement increase of 14%, resulting in an overall coefficient of performance (COP) reduction of 44%.

Low GWP refrigerant multi-component blends exhibiting similar or superior performance to R-22/R-507A refrigerants in flooded evaporator systems would be beneficial for reducing the ozone depletion potential and/or the high GWP of systems originally designed for R-22 or R-507A.

### SUMMARY

In an exemplary embodiment, a refrigeration system including a flooded evaporator. The flooded evaporator additionally includes a liquid evaporator refrigerant composition and a vapor evaporator refrigerant composition. The liquid refrigerant composition includes difluoromethane (HFC-32), and 2,3,3,3-tetrafluoropropene (R-1234yf) and the vapor refrigerant composition includes difluoromethane (HFC-32), and 2,3,3,3-tetrafluoropropene (R-1234yf). The mass fraction of difluoromethane in the liquid evaporator refrigerant composition is lower than the mass fraction of difluoromethane in the vapor evaporator refrigerant composition and the mass fraction of 2,3,3,3-tetrafluoropropene in the liquid evaporator refrigerant composition is greater than the mass fraction of 2,3,3,3-tetrafluoropropene in the vapor evaporator refrigerant composition.

In other exemplary embodiments, is a method for replacing R-22 refrigerant in flooded evaporator refrigeration systems; use of a non-azeotropic refrigerant in a refrigeration system comprising a flooded evaporator; and a method for producing cooling in a refrigeration system comprising a flooded evaporator by evaporating a non-azeotropic refrigerant.

Other features and advantages of the present invention will be apparent from the following more detailed description of the preferred embodiment which illustrates, by way of example, the principles of the invention.

### BRIEF DESCRIPTION OF THE DRAWINGS

FIG. 1 is a schematic diagram of a refrigeration system, according to an embodiment.

### DETAILED DESCRIPTION

Provided are refrigerant compositions and systems employing said compositions. The compositions provide low global warming potential (GWP) refrigerant alternatives to R-22 (ASHRAE designation for chlorodifluoromethane) and R-507A (ASHRAE designation for an azeotropic mixture containing 50 weight percent of pentafluoroethane and 50 weight percent of 1,1,1-trifluoroethane).

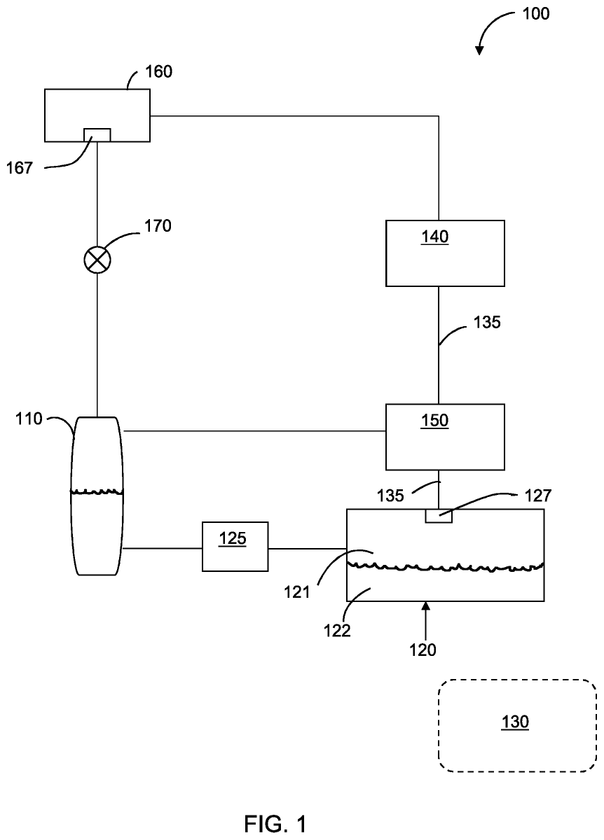

An embodiment of a refrigeration system 100 is shown in FIG. 1. In the embodiment of FIG. 1 the refrigeration system 100 includes a receiving tank 110. The receiving tank 110 contains a refrigerant composition and supplies the refrigerant composition to the other components of the refrigeration system 100 during operation.

In some embodiments, the refrigeration system is a chiller. A chiller may be a vapor compression system designed to cool a heat transfer fluid which is then used for cooling a remote artile, location or space. Chillers may be used for providing industrial or commercial air conditioning, cooling of industrial manufacturing processes, cold storage, food or pharmaceutical preparation, processing or preservation by cooling or freezing, or freezing an ice rink floor, among other uses.

The refrigerant composition may be selected from materials having a low global warming potential (GWP). In some embodiments, the refrigerant composition exhibits a GWP of less than 1800, less than 1500, less than 1400, and/or less than 1200. In some embodiments, the refrigerant composition may be selected to replace a refrigerant composition having a high GWP. In some embodiments, the refrigerant composition may be selected to replace refrigerants including chlorodifluoromethane (R-22 or HCFC-22), and R-507A, an azeotropic blend of pentafluoroethane and 1,1,1-trifluoroethane. Replacement compositions desirably provide similar or improved properties as compared to R-22 and R-507A. Similar properties may include non-flammability and heat transport capacity.

Suitable refrigerant compositions for the replacement of R-22 and R-507A refrigerants may include difluoromethane (R-32, or HFC-32), and 2,3,3,3-tetrafluoropropene (R-1234yf, or HFO-1234yf). In some embodiments, the refrigerant compositions may further include pentafluoroethane (HFC-125) and/or 1,1,1,2-tetrafluoroethane (HFC-134a) or E-1,3,3,3-tetrafluoropropene (1234ze(E)). In some embodiments, the refrigerant composition may be a non-azeotropic refrigerant composition. In some embodiments, the refrigerant compositions include refrigerant compositions designated by the American Society of Heating, Refrigerating, and Air-Conditioning Engineers, Inc. (also known as ASHRAE) as R-454A (a mixture containing 35 weight percent HFC-32 and 65 weight percent HFO-1234yf), R-454B (a mixture containing 68.9 weight percent HFC-32 and 31.1 weight percent HFO-1234yf), R-454C (a mixture containing 21.5 weight percent HFC-32 and 78.5 weight percent HFO-1234yf), R-452A (a mixture containing 11 weight percent HFC-32, 59 weight percent HFC-125, and 30 weight percent HFO-1234yf), R-452B (a mixture containing 67 weight percent HFC-32, 7 weight percent HFC-125, and 26 weight percent HFO-1234yf), R-448A (a mixture containing 26 weight percent HFC-32, 26 weight percent HFC-125, 21 weight percent HFC-134a, 20 weight percent HFO-1234yf, and 7 weight percent HFO-1234ze(trans)), R-449A (a mixture containing 24.3 weight percent HFC-32, 24.7 weight percent HFC-125, 25.7 weight percent HFC-134a, and 25.3 weight percent HFO-1234yf), R-449B (a mixture containing 25.2 weight percent HFC-32, 24.3 weight percent HFC-125, 27.3 weight percent HFC-134a, and 23.2 weight percent HFO-1234yf), and R-449C (a mixture containing 20 weight percent HFC-32, 20 weight percent HFC-125, 29 weight percent HFC-134a, and 31 weight percent HFO-1234yf).

An azeotropic composition is a constant-temperature boiling mixture of two or more substances that behave as a single substance. One way to characterize an azeotropic composition is that the vapor produced by partial evaporation or distillation of the liquid has the same composition as the liquid from which it is evaporated or distilled, i.e., the mixture distills/refluxes without compositional change.

A non-azeotropic composition is a mixture of two of more substances that behaves as a mixture. The vapor produced by partial evaporation or distillation of the liquid has a different composition from the liquid from which it is evaporated or distilled. A non-azeotropic composition may be considered near-azeotropic (also called azeotrope-like), if the vapor produced upon partial evaporation or distillation of the liquid is only slightly different from the liquid from which it is evaporated or distilled. Different definitions have been used to define a near-azeotropic composition, but for purposes of the present invention, any mixture that does not behave as a single substance, or is not an azeotrope, is considered to be non-azeotropic.

During operation of the refrigeration system 100, the refrigerant composition circulates throughout the refrigeration system 100 as part of the heat transfer processes. In the example of FIG. 1, the receiving tank 110 is operably coupled to a flooded evaporator 120 and supplies the refrigerant composition to the flooded evaporator 120. In an embodiment, the refrigerant composition is transported between the receiving tank 110 and flooded evaporator 120 by differential pressure, as in a thermo-syphon. In an embodiment, the refrigerant composition is transported between the receiving tank 110 and flooded evaporator 120 via a pump 125. In an embodiment, the refrigerant composition is a non-azeotropic composition including difluoromethane (HFC-32), and 2,3,3,3-tetrafluoropropene (R-1234yf). In some embodiments, the receiving tank 110 is optional and may be omitted.

During operation the evaporator is typically exposed to an external heat source (which may be ambient air) which causes a portion of the refrigerant composition to vaporize, thus transferring energy to the refrigerant. As a result, for a non-azeotropic composition, the composition of the vapor fraction of the refrigerants within the flooded evaporator 120 will exhibit a different composition from the liquid fraction of the refrigerants within the flooded evaporator 120, defining a vapor evaporator composition 121 and liquid evaporator composition 122 respectively, due to the non-azeotropic properties of the initial refrigerant composition. The lower boiling components of the initial refrigerant composition may be found in higher concentrations in the vapor evaporator composition 121 and the higher boiling components of the initial refrigerant composition may be found in higher concentrations in the liquid evaporator concentration.

As the liquid evaporator composition 122 becomes richer in the higher boiling components, the boiling point of the liquid evaporator composition 122 will increase from the initial bubble point and approach the dew point. This can result in shifting of the evaporator temperatures over time, ultimately reducing the efficiency of the refrigeration system 100. This change or “glide” in the boiling temperature is referred to as refrigerant temperature glide.

In an embodiment, the properties of the vapor evaporator composition 121 may be monitored at an evaporator outlet port 127 by one or more on-line sensors and/or sampling ports. The sensors may measure one or more properties of the vapor evaporator composition 121. In some embodiments, the one or more properties may include temperature and/or pressure. An optional management system 130 having a processor, memory, and instructions that allow the management system 130 to monitor and regulate the operation of the refrigeration system 100, may monitor the properties and the liquid evaporator composition 122 and vapor evaporator composition 121 to determine if within desired operating parameters.

In an embodiment, suitable mass fractions of the refrigerant composition components include a mass fraction of difluoromethane in the liquid evaporator refrigerant composition of between 0.220 and 0.350 and a mass fraction of 2,3,3,3-tetrafluoropropene in the liquid evaporator refrigerant composition of between 0.650 and 0.780 and a mass fraction of difluoromethane in the vapor evaporator refrigerant composition of between 0.401 and 0.559 and a mass fraction of 2,3,3,3-tetrafluoropropene in the vapor evaporator refrigerant composition of between 0.441 and 0.599.

In an embodiment, suitable mass fractions of the refrigerant composition components include a mass fraction of difluoromethane in the liquid evaporator refrigerant composition of between 0.072 and 0.110, a mass fraction of 2,3,3,3-tetrafluoropropene in the liquid evaporator refrigerant composition of between 0.300 and 0.400, and a mass fraction of pentafluoroethane in the liquid evaporator refrigerant composition is between 0.528 and 0.590. The mass fractions of the vapor evaporator refrigerant composition may include a mass fraction of difluoromethane in the vapor evaporator refrigerant composition of between 0.122 and 0.179, a mass fraction of 2,3,3,3-tetrafluoropropene in the vapor evaporator refrigerant composition of between 0.174 and 0.268, and a mass fraction of pentafluoroethane in the vapor evaporator refrigerant composition is between 0.610 and 0.648.

In an embodiment, suitable mass fractions of the refrigerant composition components include a mass fraction of difluoromethane in the liquid evaporator refrigerant composition of between 0.167 and 0.243, a mass fraction of 2,3,3,3-tetrafluoropropene in the liquid evaporator refrigerant composition of between 0.253 and 0.293, a mass fraction of pentafluoroethane in the liquid evaporator refrigerant composition is between 0.205 and 0.247, and a mass fraction of 1,1,1,2-tetrafluoroethane in the liquid evaporator refrigerant composition is between 0.257 and 0.336. The mass fractions of the vapor evaporator refrigerant composition may include a mass fraction of difluoromethane in the vapor evaporator refrigerant composition of between 0.274 and 0.383, a mass fraction of 2,3,3,3-tetrafluoropropene in the vapor evaporator refrigerant composition of between 0.185 and 0.237, a mass fraction of pentafluoroethane in the vapor evaporator refrigerant composition is between 0.264 and 0.304, and a mass fraction of 1,1,1,2-tetrafluoroethane in the vapor evaporator refrigerant composition of between 0.128 and 0.225.

The flooded evaporator 120 is operably connected to a compressor 140 via a suction line 135. The compressor 140 increases the pressure of the vapor evaporator composition 121 entering the compressor 140. In order to facilitate the operation and extend the service life of the compressor 140 a lubricant may be included in the refrigerant composition. Solubility and miscibility of the lubricant with the refrigerant composition may improve the performance of the lubricant and extend the service life of the compressor 140. In some embodiments, the lubricant may include mineral oil, alkylbenzene, paraffins, naphthenes, polyalpha-olefins, polyol esters, polyalkylene glycols, polyvinyl ethers, polycarbonates, perfluoropolyethers, silicones, silicate esters, phosphate esters, and combinations thereof. In one embodiment, the lubricant includes a polyol ester.

In some embodiments, an optional surge tank 150 may be inserted between the evaporator 120 and compressor 140 to prevent liquid refrigerant and/or lubricant from entering the compressor 140. The surge tank 150, if present, may return any accumulated liquids to the receiving tank 110 to again be provided to the flooded evaporator 120.

In some embodiments, the compressor of the present refrigeration system is at least one reciprocating compressor. In some embodiments, the compressor of the present invention is at least one screw compressor. In some embodiments, the compressor of the refrigeration system is selected from reciprocating or screw compressors.

The compressor 140 is operably connected to a condenser 160. The condenser 160 receives the pressurized vapor evaporator composition 121 and allows the pressurized vapor evaporator composition 121 to transfer heat to an external medium and condense to the liquid state.

As a result, for a non-azeotropic composition, the composition of the vapor fraction of the refrigerants within the condenser 160 will exhibit a different composition from the liquid fraction of the refrigerants within the condenser 160, defining a vapor condenser composition and liquid condenser composition respectively, due to the non-azeotropic properties of the refrigerant composition. The lower boiling components of the refrigerant composition may be found in higher concentrations in the vapor condenser composition and the higher boiling components of the refrigerant composition may be found in higher concentrations in the liquid condenser concentration.

In an embodiment, the properties of the liquid condenser composition may be monitored at an evaporator outlet port 167 by one or more on-line sensors and or sampling ports. The sensors may measure one or more properties of the liquid condenser composition. In some embodiments, the one or more properties may include temperature and/or pressure. An optional management system 130 having a processor, memory, and instructions that allow the management system 130 to monitor the liquid condenser composition and vapor condenser composition within desired operating parameters.

In one embodiment, the management system 130 may periodically temporarily discontinue operation of the refrigeration system 100 to allow the refrigeration components in the condenser 160 to fully condense.

The condenser 160 is operably connected to the receiving tank 110 via an expansion valve 170. The liquid condenser composition returns to the low-pressure side of the refrigeration system 100 and is again available to absorb heat by again being provided to the flooded evaporator 120.

In an alternate embodiment, receiving tank 110 may be on the high-pressure side of the refrigeration system 100 and the expansion valve 170 may be positioned between the receiving tank 110 and the flooded evaporator 120. In such embodiments, the pump 125 is typically not present.

Another exemplary embodiment includes a method for replacing R-22 refrigerant in a flooded evaporator refrigeration system comprising a) replacing a first lubricant with a second lubricant, wherein the first lubricant is a mineral oil, alkylbenzene, polyalpha-olefin, paraffins or naphthene oil and the second lubricant is a polyalkylene glycol (PAG), polyol ester (POE) or polyvinyl ether (PVE); b) recovering the R-22 refrigerant from the system and charging the system with a non-azeotropic refrigerant composition comprising 2,3,3,3-tetrafluoropropene and difluoromethane.

In one embodiment, the refrigeration system comprising a flooded evaporator is a chiller. The chiller may be used for providing industrial or commercial air conditioning, cooling of industrial manufacturing processes, cold storage, food or pharmaceutical preparation, processing or preservation by cooling or freezing, or freezing an ice rink floor, among other uses.

In another embodiment, the non-azeotropic refrigerant composition comprising 2,3,3,3-tetrafluoropropene and difluoromethane, further comprises pentafluoroethane. In yet another embodiment, the refrigerant composition further comprises pentafluoroethane and 1,1,1,2-tetrafluoroethane.

In another embodiment, the refrigerant composition comprising 2,3,3,3-tetrafluoropropene and difluoromethane is selected from the group consisting of R-448A, R-449A, R-452A, and R-454A.

Another exemplary embodiment includes the use of a non-azeotropic refrigerant composition comprising 2,3,3,3-tetrafluoropropene and difluoromethane in a refrigeration system comprising a flooded evaporator, wherein the system was designed for use with R-22 refrigerant. In one embodiment, the refrigeration system comprising a flooded evaporator may be a chiller. In some embodiments, the chiller may be used for providing air conditioning or freezing an ice rink floor.

In another embodiment, the non-azeotropic refrigerant composition used in the refrigeration system further comprises pentafluoroethane. In another embodiment, the non-azeotropic refrigerant composition further comprises pentafluoroethane and 1,1,1,2-tetrafluoroethane. In one embodiment, the non-azeotropic refrigerant composition is selected from the group consisting of R-448A, R-449A, R-452A, and R-454A.

Another exemplary embodiment includes a method for producing cooling comprising evaporating a non-azeotropic refrigerant composition comprising 2,3,3,3-tetrafluoropropene and difluoromethane in a flooded evaporator in the vicinity of a body to be cooled, and then condensing said non-azeotropic composition. The flooded evaporator is a component of a refrigeration system as described in FIG. 1. The refrigeration system may be a chiller and the body to be cooled may be a heat transfer fluid that transports the cooling to a remote location. The heat transfer fluid may be an aqueous brine solution, such as for instance calcium chloride brine, or a glycol, such as for instance ethylene glycol or propylene glycol solution. The remote location may be a space for air conditioning or it may be the floor of an ice rink for cooling the ice. In another embodiment, the non-azeotropic refrigerant composition may further comprise pentafluoroethane. In another embodiment, the non-azeotropic refrigerant composition further comprises pentafluoroethane and 1,1,1,2-tetrafluoroethane. In one embodiment, the non-azeotropic refrigerant composition is selected from the group consisting of R-448A, R-449A, R-452A, and R-454A.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

### EXAMPLES

### Example 1

### Refrigerant Performance

In order to better understand how the system would operate with a non-azeotropic refrigerant mixture in place of R-22, proprietary software was developed that could not only demonstrate the typical performance parameters, but could estimate the changes in the non-azeotropic refrigerant composition as it moved through the cycle. The model assumes steady state behavior and doesn't consider any dynamic behavior involving transport phenomena, e.g. heat transfer resistance. It includes a flooded evaporator with variable fill height, a surge tank, single stage compressor, (operates at an isotropic efficiency), a condenser that provides total condensation, a collection tank and an isenthalpic expansion valve. The mass and energy balances use published equations of state and mixing parameters for the mixture components for energic and phase equilibria cycle calculations with NIST's REFPROP.

### Conditions:

Flooded Evaporator System

Temp_condenser=90.0° F.

Temp_evaporator=10.0° F.

compressor efficiency=0.75

TABLE 1a

| | | | | condenser | | |
|---|---|---|---|---|---|---|
| | T_disch | P_evap | P_cond | glide | CAP | |
| fluid | (deg F.) | (psia) | (psia) | (degR) | (Btu/ft³) | COP |
| R-22 | 154 | 47.5 | 183 | 0 | 61.3 | 3.6 |
| R-507AA | 112 | 60.4 | 224 | 0.065 | 62.8 | 3.2 |
| R-449A | 141 | 56.5 | 236 | 6.3 | 67.8 | 3.2 |
| R-452A | 121 | 59.7 | 238 | 4.6 | 65.3 | 3.1 |
| R-454A | 148 | 61.5 | 247 | 5.4 | 74.0 | 3.3 |
| R-454B | 166 | 73.0 | 278 | 1.6 | 89.9 | 3.4 |
| R-454C | 140 | 53.3 | 224 | 8.7 | 63.2 | 3.2 |

Predicted ranges for compositions in the evaporator at evaporator fill heights from 0.01 to 0.9 fraction by volume (volume of the evaporator containing liquid) for each of the refrigerant mixtures above, are as shown in Table 1b.

TABLE 1b

| Refrigerant | Weight fraction | | | | | | | |
|---|---|---|---|---|---|---|---|---|
| charged to | HFC-32 | | HFC-125 | | HFO-1234yf | | HFC-134a | |
| the system | Liquid | Vapor | Liquid | Vapor | Liquid | Vapor | Liquid | Vapor |
| R449A | 0.167- | 0.274- | 0.205- | 0.264- | 0.253- | 0.185- | 0.257- | 0.128- |
| | 0.243 | 0.383 | 0.247 | 0.304 | 0.293 | 0.237 | 0.336 | 0.225 |
| R452A | 0.072- | 0.122- | 0.537- | 0.624- | 0.389- | 0.244- | | |
| | 0.110 | 0.179 | 0.590 | 0.644 | 0.300 | 0.183 | | |
| R454A | 0.22- | 0.40- | | | 0.65- | 0.441- | | |
| | 0.35 | 0.559 | | | 0.78 | 0.599 | | |
| R454B | 0.623- | 0.737- | | | 0.377- | 0.263- | | |
| | 0.689 | 0.783 | | | 0.311 | 0.217 | | |
| R454C | 0.115- | 0.299- | | | 0.885- | 0.701- | | |
| | 0.215 | 0.423 | | | 0.785 | 0.577 | | |

### Example 2

### Retrofit of R-22 System Using R-449A

An indirect ice rink chiller with a flooded evaporator that operated with R-22 was retrofit using R-449A. The chiller included multiple reciprocating compressors, an evaporative condenser, and a shell and tube flooded evaporator. Calcium chloride brine was used to cool the ice rink floor.

System performance was monitored and quantified both pre- and post-retrofit using a total system power meter, brine flow, and brine temperature drop through the evaporator. Total system power measurements included draw from compressor motors, the condenser water pump, brine circulation pumps, subfloor glycol pumps, snowmelt pumps, and ancillary equipment such as crankcase heaters and controls. Brine flow and temperature drop through the evaporator was used to evaluate evaporator heat load.

The retrofit consisted of an oil change from mineral oil to POE (polyol ester) oil and the replacement of critical elastomeric seals to prevent leaks after removal of the R-22 and the subsequent shrinkage of the elastomer that might ultimately result. R-22 refrigerant was recovered, and the system was charged with R-449A. The brine temperature was maintained at about 14 to 18° F. throughout the test. The system has remained operating successfully with R-449A for a period of about 9 months.

A sample of the evaporator vapor was taken (at the compressor outlet) and showed a good match to the modeled composition for that point in the cycle from the above calculations. These results are shown in Table 2.

TABLE 2

| | Weight fraction | | | |
|---|---|---|---|---|
| source | HFC-32 | HFC-125 | HFO-1234yf | HFC-134a |
| sample | 0.34 | 0.302 | 0.192 | 0.164 |
| model | 0.34 | 0.292 | 0.204 | 0.163 |

The retrofit demonstrates the viability of using a non-azeotropic refrigerant in a flooded evaporator chiller designed for R-22 with only minor system modifications. Suction and discharge pressures of R-449A were comparable to R-22 operation and within the limits of existing system components. A comparison of energy usage for days with similar ambient temperature profiles unexpectedly showed no significant difference between the two fluids.

### ADDITIONAL EMBODIMENTS

Embodiment A1: A refrigeration system comprising:
a flooded evaporator;
wherein the flooded evaporator further comprises:
   a liquid evaporator refrigerant composition; and
   a vapor evaporator refrigerant composition;
wherein the liquid refrigerant composition comprises difluoromethane (HFC-32), and 2,3,3,3-tetrafluoropropene (R-1234yf);
wherein the vapor refrigerant composition comprises difluoromethane (HFC-32), and 2,3,3,3-tetrafluoropropene (R-1234yf);
wherein the mass fraction of difluoromethane in the liquid evaporator refrigerant composition is lower than the mass fraction of difluoromethane in the vapor evaporator refrigerant composition; and
wherein the mass fraction of 2,3,3,3-tetrafluoropropene in the liquid evaporator refrigerant composition is greater than the mass fraction of 2,3,3,3-tetrafluoropropene in the vapor evaporator refrigerant composition.

Embodiment A2: The refrigeration system of Embodiment A1:
wherein the mass fraction of difluoromethane in the liquid evaporator refrigerant composition is between 0.220 and 0.350;
wherein the mass fraction of 2,3,3,3-tetrafluoropropene in the liquid evaporator refrigerant composition is between 0.650 and 0.780;
wherein the mass fraction of difluoromethane in the vapor evaporator refrigerant composition is between 0.401 and 0.559; and
wherein the mass fraction of 2,3,3,3-tetrafluoropropene in the vapor evaporator refrigerant composition is between 0.441 and 0.599.

Embodiment A3: The refrigeration system of any of Embodiments A1 or A2:
wherein the mass fraction of difluoromethane in the liquid evaporator refrigerant composition is between 0.072 and 0.110;
wherein the mass fraction of 2,3,3,3-tetrafluoropropene in the liquid evaporator refrigerant composition is between 0.300 and 0.400;
wherein the liquid evaporator refrigerant composition further comprises pentafluoroethane (HFC-125);
wherein the mass fraction of pentafluoroethane in the liquid evaporator refrigerant composition is between 0.528 and 0.590;
wherein the mass fraction of difluoromethane in the vapor evaporator refrigerant composition is between 0.122 and 0.179;
wherein the mass fraction of 2,3,3,3-tetrafluoropropene in the vapor evaporator refrigerant composition is between 0.174 and 0.268;
wherein the vapor evaporator refrigerant composition further comprises pentafluoroethane (HFC-125); and
wherein the mass fraction of pentafluoroethane in the vapor evaporator refrigerant composition is between 0.610 and 0.648.

Embodiment A4: The refrigeration system of any of Embodiments A1 to A3:
wherein the mass fraction of difluoromethane in the liquid evaporator refrigerant composition is between 0.167 and 0.243;
wherein the mass fraction of 2,3,3,3-tetrafluoropropene in the liquid evaporator refrigerant composition is between 0.253 and 0.293;
wherein the liquid evaporator refrigerant composition further comprises pentafluoroethane (HFC-125);
wherein the mass fraction of pentafluoroethane in the liquid evaporator refrigerant composition is between 0.205 and 0.247;
wherein the liquid evaporator refrigerant composition further comprises 1,1,1,2-tetrafluoroethane (HFC-134a);
wherein the mass fraction of 1,1,1,2-tetrafluoroethane in the liquid evaporator refrigerant composition is between 0.257 and 0.336;
wherein the mass fraction of difluoromethane in the vapor evaporator refrigerant composition is between 0.274 and 0.383;
wherein the mass fraction of 2,3,3,3-tetrafluoropropene in the vapor evaporator refrigerant composition is between 0.185 and 0.237;
wherein the vapor evaporator refrigerant composition further comprises pentafluoroethane (HFC-125);
wherein the mass fraction of pentafluoroethane in the vapor evaporator refrigerant composition is between 0.264 and 0.304;
wherein the vapor evaporator refrigerant composition further comprises 1,1,1,2-tetrafluoroethane (HFC-134a); and
wherein the mass fraction of 1,1,1,2-tetrafluoroethane in the vapor evaporator refrigerant composition is between 0.128 and 0.225.

Embodiment A5: The system of any of Embodiments A1 to A4, wherein the liquid evaporator refrigerant composition and the vapor evaporator refrigerant composition exhibit a global warming potential of less than 1500.

Embodiment A6: The system of any of Embodiments A1 to A5, wherein the liquid evaporator refrigerant composition further includes a lubricant.

Embodiment A7: The system of any of Embodiments A1 to A6, wherein the lubricant is selected from the group consisting of mineral oil, alkylbenzene, polyol esters, polyalkylene glycols, polyvinyl ethers, polycarbonates, perfluoropolyethers, silicones, silicate esters, phosphate esters, paraffins, naphthenes, polyalpha-olefins, and combinations thereof.

Embodiment A8: The system of any of Embodiments A1 to A7, wherein the compressor is at least one screw compressor or at least one reciprocating compressor.

Embodiment B1: A method of reducing temperature glide in a refrigeration system, the refrigeration system including a receiving tank including an inlet port and outlet port, an evaporator including an inlet port and an outlet port, an evaporator outlet port sensor, a surge tank including a first inlet port and an outlet port, a compressor including an inlet port and an outlet port, a condenser including an inlet port and an outlet port, a condenser outlet port sensor, and an expansion valve including an inlet port and an outlet port, a management system including a processor, a memory, and instructions that when executed by the processor allow the management system to regulate the operation of the refrigeration system, the method comprising the steps of:
providing a non-azeotropic liquid refrigerant composition including at least a first refrigerant and a second refrigerant from the receiving tank to the evaporator;
heating the non-azeotropic refrigerant composition in the evaporator sufficiently to evaporate a portion of the non-azeotropic liquid refrigerant composition to form a first vapor evaporator refrigerant composition and a first liquid evaporator refrigerant composition at a first time;
receiving, by the management system, a first evaporator outlet measurement from the evaporator outlet port sensor at the first time;
heating the first liquid evaporator refrigerant composition in the evaporator sufficiently to evaporate a portion of the first liquid evaporator refrigerant composition to form a second vapor evaporator refrigerant composition and a second liquid evaporator refrigerant composition at a second time;
receiving, by the management system, a second evaporator outlet measurement from the evaporator outlet port sensor at the second time;
determining, by the management system, a difference between the first evaporator outlet measurement and the second evaporator outlet measurement is greater than a predetermined threshold;
regulating, by the management system, the operation of the refrigeration system based on the first evaporator outlet measurement and the second evaporator outlet measurement.

Embodiment B2: The method of Embodiment B1, wherein the first evaporator outlet measurement includes a temperature and the second evaporator outlet measurement includes a temperature.

Emobidment B3: The method of any of Embodiments B1 or B2, wherein the first evaporator outlet measurement further includes a pressure and the second evaporator outlet measurement further includes a pressure.

Embodiment B4: The method of any of Embodiments B1 to B3, wherein the predetermined threshold is less than the difference between the bubble point of the non-azeotropic liquid refrigerant composition and the boiling point of the highest boiling component of the non-azeotropic liquid refrigerant composition.

Embodiment B5: The method of Embodiments B1 to B4, wherein the predetermined threshold is less than 80 percent of the difference between the bubble point of the non-azeotropic liquid refrigerant composition and the boiling point of the highest boiling component of the non-azeotropic liquid refrigerant composition.

Embodiment B6: The method of any of Embodiments B1 to B5:
wherein regulating the operation of the refrigeration system includes adding a portion of the second liquid refrigerant composition to the surge tank via a second surge tank inlet port; and
wherein rate of addition of the second liquid refrigerant composition to the surge tank is less than 5 percent of the mass of vapor refrigerant entering the surge tank via the first surge tank inlet port.

Embodiment B7: The method of any of Embodiments B1 to B6:
wherein the mass fraction of difluoromethane in the first liquid evaporator refrigerant composition is between 0.220 and 0.350;
wherein the mass fraction of 2,3,3,3-tetrafluoropropene in the first liquid evaporator refrigerant composition is between 0.650 and 0.780;
wherein the mass fraction of difluoromethane in the first vapor evaporator refrigerant composition is between 0.401 and 0.559; and
wherein the mass fraction of 2,3,3,3-tetrafluoropropene in the first vapor evaporator refrigerant composition is between 0.441 and 0.599.

Embodiment B8: The method of any of Embodiments B1 to B6:
wherein the mass fraction of difluoromethane in the first liquid evaporator refrigerant composition is between 0.072 and 0.110;
wherein the mass fraction of 2,3,3,3-tetrafluoropropene in the first liquid evaporator refrigerant composition is between 0.300 and 0.400;
wherein the first liquid evaporator refrigerant composition further comprises pentafluoroethane (HFC-125),
wherein the mass fraction of pentafluoroethane in the first liquid evaporator refrigerant composition is between 0.528 and 0.590;
wherein the mass fraction of difluoromethane in the first vapor evaporator refrigerant composition is between 0.122 and 0.179;
wherein the mass fraction of 2,3,3,3-tetrafluoropropene in the first vapor evaporator refrigerant composition is between 0.174 and 0.268;
wherein the first vapor evaporator refrigerant composition further comprises pentafluoroethane (HFC-125); and
wherein the mass fraction of pentafluoroethane in the first vapor evaporator refrigerant composition is between 0.610 and 0.648.

Embodiment B9: The method of any of Embodiments B1 to B6:
wherein the mass fraction of difluoromethane in the first liquid evaporator refrigerant composition is between 0.167 and 0.243;
wherein the mass fraction of 2,3,3,3-tetrafluoropropene in the first liquid evaporator refrigerant composition is between 0.253 and 0.293;
wherein the first liquid evaporator refrigerant composition further comprises pentafluoroethane (HFC-125);
wherein the mass fraction of pentafluoroethane in the first liquid evaporator refrigerant composition is between 0.205 and 0.247;
wherein the first liquid evaporator refrigerant composition further comprises 1,1,1,2-tetrafluoroethane (HFC-134a);
wherein the mass fraction of 1,1,1,2-tetrafluoroethane in the first liquid evaporator refrigerant composition is between 0.257 and 0.336;
wherein the mass fraction of difluoromethane in the first vapor evaporator refrigerant composition is between 0.274 and 0.383;
wherein the mass fraction of 2,3,3,3-tetrafluoropropene in the first vapor evaporator refrigerant composition is between 0.185 and 0.237;
wherein the first vapor evaporator refrigerant composition further comprises pentafluoroethane (HFC-125);
wherein the mass fraction of pentafluoroethane in the first vapor evaporator refrigerant composition is between 0.264 and 0.304;
wherein the first vapor evaporator refrigerant composition further comprises 1,1,1,2-tetrafluoroethane (HFC-134a); and
wherein the mass fraction of 1,1,1,2-tetrafluoroethane in the first vapor evaporator refrigerant composition is between 0.128 and 0.225.

Embodiment B10: The system of any of Embodiments B1 to B9, wherein the compressor is at least one screw compressor or at least one reciprocating compressor.

Embodiment C1: A refrigerant composition comprising:
a liquid refrigerant composition; and
a vapor refrigerant composition in contact with the liquid refrigerant composition;
wherein the liquid refrigerant composition comprises difluoromethane (HFC-32), and 2,3,3,3-tetrafluoropropene (R-1234yf);
wherein the vapor refrigerant composition comprises difluoromethane (HFC-32), and 2,3,3,3-tetrafluoropropene (R-1234yf);
wherein the mass fraction of difluoromethane in the liquid refrigerant composition is lower than the mass fraction of difluoromethane in the vapor refrigerant composition; and
wherein the mass fraction of 2,3,3,3-tetrafluoropropene in the liquid refrigerant composition is greater than the mass fraction of 2,3,3,3-tetrafluoropropene in the vapor refrigerant composition.

Embodiment C2: The composition of Embodiment C1:
wherein the mass fraction of difluoromethane in the liquid refrigerant composition is between 0.220 and 0.350;
wherein the mass fraction of 2,3,3,3-tetrafluoropropene in the liquid refrigerant composition is between 0.650 and 0.780;
wherein the mass fraction of difluoromethane in the vapor refrigerant composition is between 0.401 and 0.559; and
wherein the mass fraction of 2,3,3,3-tetrafluoropropene in the vapor refrigerant composition is between 0.441 and 0.599.

Embodiment C3: The composition of Embodiment C1:
wherein the mass fraction of difluoromethane in the liquid refrigerant composition is between 0.072 and 0.110;
wherein the mass fraction of 2,3,3,3-tetrafluoropropene in the liquid refrigerant composition is between 0.300 and 0.400;
wherein the liquid refrigerant composition further comprises pentafluoroethane (HFC-125);
wherein the mass fraction of pentafluoroethane in the liquid refrigerant composition is between 0.528 and 0.590;
wherein the mass fraction of difluoromethane in the vapor refrigerant composition is between 0.122 and 0.179;
wherein the mass fraction of 2,3,3,3-tetrafluoropropene in the vapor refrigerant composition is between 0.174 and 0.268;
wherein the vapor refrigerant composition further comprises pentafluoroethane (HFC-125); and
wherein the mass fraction of pentafluoroethane in the vapor refrigerant composition is between 0.610 and 0.648.

Embodiment C4: The composition of Embodiment C1:
wherein the mass fraction of difluoromethane in the liquid refrigerant composition is between 0.167 and 0.243;
wherein the mass fraction of 2,3,3,3-tetrafluoropropene in the liquid refrigerant composition is between 0.253 and 0.293;
wherein the liquid refrigerant composition further comprises pentafluoroethane (HFC-125);
wherein the mass fraction of pentafluoroethane in the liquid refrigerant composition is between 0.205 and 0.247;
wherein the liquid refrigerant composition further comprises 1,1,1,2-tetrafluoroethane (HFC-134a);
wherein the mass fraction of 1,1,1,2-tetrafluoroethane in the liquid refrigerant composition is between 0.257 and 0.336;
wherein the mass fraction of difluoromethane in the vapor refrigerant composition is between 0.274 and 0.383;
wherein the mass fraction of 2,3,3,3-tetrafluoropropene in the vapor refrigerant composition is between 0.185 and 0.237;
wherein the vapor refrigerant composition further comprises pentafluoroethane (HFC-125);
wherein the mass fraction of pentafluoroethane in the vapor refrigerant composition is between 0.264 and 0.304;
wherein the vapor refrigerant composition further comprises 1,1,1,2-tetrafluoroethane (HFC-134a); and
wherein the mass fraction of 1,1,1,2-tetrafluoroethane in the vapor evaporator refrigerant composition is between 0.128 and 0.225.

Embodiment C5: The composition of any of Embodiments C1 to C4, further comprising E-1,3,3,3-tetrafluoropropene (1234ze(E)).

Embodiment D1: A method for replacing R-22 refrigerant in flooded evaporator refrigeration systems comprising:
a. replacing a first lubricant with a second lubricant, wherein the first lubricant is a mineral oil, alkylbenzene, polyalpha-olefin, paraffins or naphthene oil and the second lubricant is a polyol ester (POE) or polyvinyl ether (PVE);
b. recovering the R-22 refrigerant from the system and charging with a non-azeotropic refrigerant composition comprising 2,3,3,3-tetrafluoropropene and difluoromethane.

Embodiment D2: The use of Embodiment D1, wherein the refrigeration system comprising a flooded evaporator is a chiller.

Embodiment D3: The use of any of Embodiment D1 or D2, wherein the refrigeration system comprising a flooded evaporator is a chiller and is used for providing industrial or commercial air conditioning, cooling of industrial manufacturing processes, cold storage, food or pharmaceutical preparation, processing or preservation by cooling or freezing, or freezing an ice rink floor.

Embodiment D4: The method of any of Embodiments D1 to D3, wherein the refrigerant composition further comprises pentafluoroethane.

Embodiment D5: The method of any of Embodiments D1 to D4, wherein the refrigerant composition further comprises pentafluoroethane and 1,1,1,2-tetrafluoroethane.

Embodiment D6: The method of any of Embodiments D1 to D5, wherein the refrigerant composition is selected from the group consisting of R-449, R-452, and R-454.

Embodiment D7: The method of claim 22, wherein the refrigerant composition is selected from the group consisting of R-448A, R-449A, R-452A, and R-454A.

Embodiment D8: The system of any of Embodiments D1 to D7, wherein the compressor is at least one screw compressor or at least one reciprocating compressor.

Embodiment E1: Use of a refrigerant composition comprising 2,3,3,3-tetrafluoropropene and difluoromethane in a refrigeration system comprising a flooded evaporator, wherein the system was designed for use with R-22 refrigerant.

Embodiment E2: The use of Embodiment E1, wherein the refrigeration system comprising a flooded evaporator is a chiller.

Embodiment E3: The use of any of Embodiments E1 or E2, wherein the chiller is used for providing industrial or commercial air conditioning, cooling of industrial manufacturing processes, cold storage, food or pharmaceutical preparation, processing or preservation by cooling or freezing, or freezing an ice rink floor.

Embodiment E4: The use of any of Embodiments E1 to E3, wherein the refrigerant composition further comprises pentafluoroethane.

Embodiment E5: The use of any of Embodiments E1 to E4, wherein the refrigerant composition further comprises pentafluoroethane and 1,1,1,2-tetrafluoroethane.

Embodiment E6: The use of Any of Embodiments E1 to E5, wherein the refrigerant composition is selected from the group consisting of R-448, R-449, R-452, and R-454.

Embodiment E7: The use of any of Embodiments E1 to E6, wherein the refrigerant composition is selected from the group consisting of R-448A, R-449A, R-452A, and R-454A.

Embodiment E8: The system of any of Embodiments A1 to A7, wherein the refrigeration system further comprises at least one compressor which is at least one screw compressor or at least one reciprocating compressor.

Embodiment F1: A method for producing cooling comprising evaporating a non-azeotropic refrigerant composition comprising 2,3,3,3-tetrafluoropropene and difluoromethane in a flooded evaporator in the vicinity of a body to be cooled, and then condensing said non-azeotropic composition, wherein the flooded evaporator is a component of a refrigeration system.

Embodiment F2: The method of Embodiment F1, wherein the refrigeration system is a chiller.

Embodiment F3: The method of embodiment F1 or F2, wherein the body to be cooled is a heat transfer fluid that transports the cooling to a remote location.

Embodiment F4: The method of any of Embodiments F1 to F3, wherein the refrigeration system provides industrial or commercial air conditioning, cooling of industrial manufacturing processes, cold storage, food or pharmaceutical preparation, processing or preservation by cooling or freezing, or freezing an ice rink floor.

Embodiment F5: The method of any of Embodiments F1 to F4, wherein the non-azeotropic refrigerant composition further comprises pentafluoroethane.

Embodiment F6: The method of any of Embodiments F1 to F5, wherein the non-azeotropic refrigerant composition further comprises pentafluoroethane and 1,1,1,2-tetrafluoroethane.

Embodiment F7: The method of any of Embodiments F1 to F6, wherein the non-azeotropic refrigerant composition is selected from the group consisting of R-448A, R-449A, R-452A, and R-454A.

1. A refrigeration system comprising:
a flooded evaporator;
wherein the flooded evaporator further comprises:
a liquid evaporator refrigerant composition; and
a vapor evaporator refrigerant composition;
wherein the liquid refrigerant composition comprises difluoromethane (HFC-32), and 2,3,3,3-tetrafluoropropene (R-1234yf);
wherein the vapor refrigerant composition comprises difluoromethane (HFC-32), and 2,3,3,3-tetrafluoropropene (R-1234yf);
wherein the mass fraction of difluoromethane in the liquid evaporator refrigerant composition is lower than the mass fraction of difluoromethane in the vapor evaporator refrigerant composition; and
wherein the mass fraction of 2,3,3,3-tetrafluoropropene in the liquid evaporator refrigerant composition is greater than the mass fraction of 2,3,3,3-tetrafluoropropene in the vapor evaporator refrigerant composition.

2. The refrigeration system of claim 1:
wherein the mass fraction of difluoromethane in the liquid evaporator refrigerant composition is between 0.220 and 0.350;
wherein the mass fraction of 2,3,3,3-tetrafluoropropene in the liquid evaporator refrigerant composition is between 0.650 and 0.780;
wherein the mass fraction of difluoromethane in the vapor evaporator refrigerant composition is between 0.401 and 0.559; and
wherein the mass fraction of 2,3,3,3-tetrafluoropropene in the vapor evaporator refrigerant composition is between 0.441 and 0.599.

3. The refrigeration system of claim 1:
wherein the mass fraction of difluoromethane in the liquid evaporator refrigerant composition is between 0.072 and 0.110;
wherein the mass fraction of 2,3,3,3-tetrafluoropropene in the liquid evaporator refrigerant composition is between 0.300 and 0.400;
wherein the liquid evaporator refrigerant composition further comprises pentafluoroethane (HFC-125);
wherein the mass fraction of pentafluoroethane in the liquid evaporator refrigerant composition is between 0.528 and 0.590;
wherein the mass fraction of difluoromethane in the vapor evaporator refrigerant composition is between 0.122 and 0.179;
wherein the mass fraction of 2,3,3,3-tetrafluoropropene in the vapor evaporator refrigerant composition is between 0.174 and 0.268;
wherein the vapor evaporator refrigerant composition further comprises pentafluoroethane (HFC-125); and
wherein the mass fraction of pentafluoroethane in the vapor evaporator refrigerant composition is between 0.610 and 0.648.

4. The refrigeration system of claim 1:
wherein the mass fraction of difluoromethane in the liquid evaporator refrigerant composition is between 0.167 and 0.243;
wherein the mass fraction of 2,3,3,3-tetrafluoropropene in the liquid evaporator refrigerant composition is between 0.253 and 0.293;
wherein the liquid evaporator refrigerant composition further comprises pentafluoroethane (HFC-125);
wherein the mass fraction of pentafluoroethane in the liquid evaporator refrigerant composition is between 0.205 and 0.247;
wherein the liquid evaporator refrigerant composition further comprises 1,1,1,2-tetrafluoroethane (HFC-134a);
wherein the mass fraction of 1,1,1,2-tetrafluoroethane in the liquid evaporator refrigerant composition is between 0.257 and 0.336;
wherein the mass fraction of difluoromethane in the vapor evaporator refrigerant composition is between 0.274 and 0.383;
wherein the mass fraction of 2,3,3,3-tetrafluoropropene in the vapor evaporator refrigerant composition is between 0.185 and 0.237;
wherein the vapor evaporator refrigerant composition further comprises pentafluoroethane (HFC-125);
wherein the mass fraction of pentafluoroethane in the vapor evaporator refrigerant composition is between 0.264 and 0.304;
wherein the vapor evaporator refrigerant composition further comprises 1,1,1,2-tetrafluoroethane (HFC-134a); and
wherein the mass fraction of 1,1,1,2-tetrafluoroethane in the vapor evaporator refrigerant composition is between 0.128 and 0.225.

5. The system of claim 1, wherein the liquid evaporator refrigerant composition and the vapor evaporator refrigerant composition exhibit a global warming potential of less than 1500.

6. The system of claim 1, wherein the liquid evaporator refrigerant composition further includes a lubricant.

7. (canceled)

8. A refrigerant composition comprising:
a liquid refrigerant composition; and
a vapor refrigerant composition in contact with the liquid refrigerant composition;
wherein the liquid refrigerant composition comprises difluoromethane (HFC-32), and 2,3,3,3-tetrafluoropropene (R-1234yf);
wherein the vapor refrigerant composition comprises difluoromethane (HFC-32), and 2,3,3,3-tetrafluoropropene (R-1234yf);
wherein the mass fraction of difluoromethane in the liquid refrigerant composition is lower than the mass fraction of difluoromethane in the vapor refrigerant composition; and
wherein the mass fraction of 2,3,3,3-tetrafluoropropene in the liquid refrigerant composition is greater than the mass fraction of 2,3,3,3-tetrafluoropropene in the vapor refrigerant composition.

9. The composition of claim 8:
wherein the mass fraction of difluoromethane in the liquid refrigerant composition is between 0.220 and 0.350;
wherein the mass fraction of 2,3,3,3-tetrafluoropropene in the liquid refrigerant composition is between 0.650 and 0.780;
wherein the mass fraction of difluoromethane in the vapor refrigerant composition is between 0.401 and 0.559; and
wherein the mass fraction of 2,3,3,3-tetrafluoropropene in the vapor refrigerant composition is between 0.441 and 0.599.

10. The composition of claim 8:
wherein the mass fraction of difluoromethane in the liquid refrigerant composition is between 0.072 and 0.110;
wherein the mass fraction of 2,3,3,3-tetrafluoropropene in the liquid refrigerant composition is between 0.300 and 0.400;
wherein the liquid refrigerant composition further comprises pentafluoroethane (HFC-125);
wherein the mass fraction of pentafluoroethane in the liquid refrigerant composition is between 0.528 and 0.590;
wherein the mass fraction of difluoromethane in the vapor refrigerant composition is between 0.122 and 0.179;
wherein the mass fraction of 2,3,3,3-tetrafluoropropene in the vapor refrigerant composition is between 0.174 and 0.268;
wherein the vapor refrigerant composition further comprises pentafluoroethane (HFC-125); and
wherein the mass fraction of pentafluoroethane in the vapor refrigerant composition is between 0.610 and 0.648.

11. The composition of claim 8:
wherein the mass fraction of difluoromethane in the liquid refrigerant composition is between 0.167 and 0.243;
wherein the mass fraction of 2,3,3,3-tetrafluoropropene in the liquid refrigerant composition is between 0.253 and 0.293;
wherein the liquid refrigerant composition further comprises pentafluoroethane (HFC-125);
wherein the mass fraction of pentafluoroethane in the liquid refrigerant composition is between 0.205 and 0.247;
wherein the liquid refrigerant composition further comprises 1,1,1,2-tetrafluoroethane (HFC-134a);
wherein the mass fraction of 1,1,1,2-tetrafluoroethane in the liquid refrigerant composition is between 0.257 and 0.336;
wherein the mass fraction of difluoromethane in the vapor refrigerant composition is between 0.274 and 0.383;
wherein the mass fraction of 2,3,3,3-tetrafluoropropene in the vapor refrigerant composition is between 0.185 and 0.237;
wherein the vapor refrigerant composition further comprises pentafluoroethane (HFC-125);
wherein the mass fraction of pentafluoroethane in the vapor refrigerant composition is between 0.264 and 0.304;
wherein the vapor refrigerant composition further comprises 1,1,1,2-tetrafluoroethane (HFC-134a); and
wherein the mass fraction of 1,1,1,2-tetrafluoroethane in the vapor evaporator refrigerant composition is between 0.128 and 0.225.

12. The composition of claim 8, further comprising E-1,3,3,3-tetrafluoropropene (1234ze(E)).

13. A method for replacing R-22 refrigerant in flooded evaporator refrigeration systems comprising:
a. replacing a first lubricant with a second lubricant, wherein the first lubricant is a mineral oil, alkylbenzene, polyalpha-olefin, paraffins or naphthene oil and the second lubricant is a polyol ester (POE) or polyvinyl ether (PVE);
b. recovering the R-22 refrigerant from the system and charging with a non-azeotropic refrigerant composition comprising 2,3,3,3-tetrafluoropropene and difluoromethane.

14. The method of claim 13, wherein the refrigeration system comprising a flooded evaporator is a chiller.

15. The method of claim 13, wherein the chiller is used for providing industrial or commercial air conditioning, cooling of industrial manufacturing processes, cold storage, food or pharmaceutical preparation, processing or preservation by cooling or freezing, or freezing an ice rink floor.

16. The method of claim 13, wherein the refrigerant composition further comprises pentafluoroethane.

17. The method of claim 13, wherein the refrigerant composition further comprises pentafluoroethane and 1,1,1,2-tetrafluoroethane.

18. The method of claim 13, wherein the refrigerant composition is selected from the group consisting of R-448A, R-449A, R-452A, and R-454A.

19-24. (canceled)

25. A method for producing cooling comprising evaporating a non-azeotropic refrigerant composition comprising 2,3,3,3-tetrafluoropropene and difluoromethane in a flooded evaporator in the vicinity of a body to be cooled, and then condensing said non-azeotropic composition, wherein the flooded evaporator is a component of a refrigeration system.

26-31. (canceled)
